(19) United States
(12) Patent Application Publication
(10) Pub. No.: US 2006/0292363 A1
(43) Pub. Date: Dec. 28, 2006

(54) Method of fabricating an environmentally friendly cladding layer

(76) Inventor: Shih-Chuan Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/431,698

(22) Filed: May 11, 2006

(30) Foreign Application Priority Data
Jun. 24, 2005 (TW) 94121276

(51) Int. Cl. B32B 15/04; B32B 27/38; B32B 27/40; B32B 15/08; G11B 11/105; B32B 27/00

(52) U.S. Cl. 428/332; 428/457; 428/416; 428/425.8; 428/463; 428/460; 428/461; 427/248.1; 427/402; 156/155

(57) ABSTRACT

A method of fabricating an environmentally friendly cladding layer is provided. A metal layer is deposited on a hydrolysis film by a vacuum evaporation method. Then, after coating a polymer adhesive on the metal layer, the hydrolysis film is immersed in water. After hydrolyzing the hydrolysis film, an electroplate is adhered on the metal layer through the polymer adhesive. Finally, the polymer adhesive, the metal layer and the electroplate are baked for thermosetting the polymer adhesive.

### RELATED APPLICATIONS

The present application is based on, and claims priority from, Taiwan Application Serial Number 94121276, filed Jun. 24, 2005, the disclosure of which is hereby incorporated by reference herein in its entirety.

### BACKGROUND

1. Field of Invention

The present invention relates to a method of fabricating a cladding layer. More particularly, the present invention relates to a method of fabricating an environmentally friendly cladding layer.

2. Description of Related Art

Electroplating is a commonly used surface treatment method. Electroplating is an electrolytic process, wherein an anode metal plate and a cathode electroplate are dipped in a bath filled with an appropriate electrolytic solution. The electrolytic solution is usually an ionic solution of the anode metal. While electric current passes through the anode and the cathode, metal ions in the electrolytic solution are attracted to the cathode and the anode metal plate is dissolved to provide more metal ions, thus depositing the metal on the surface of the cathode electroplate.

The electroplating waste liquid often contains hazardous pollutants, such as heavy metal or cyanide. Therefore, the selection of plating solvent and concentration of heavy metal ions should be carefully considered. However, untreated electroplating liquid containing hazardous pollutants or treated electroplate waste liquid that doesn't satisfy the effluent standard is still often poured into sewers to cause serious pollution of groundwater, rivers and oceans and directly and indirectly affecting human health.

Other plating methods, such as sputtering, simply aren't as cost-effective as electrolytic electroplating, have pollution problems of their own, often require longer processing times, cannot plate a large electroplate, and cannot yield a uniform coating thickness on a rough surface of the electroplate.

Thus, a method of fabricating an environmentally friendly cladding layer is required to solve these problems.

### SUMMARY

In one aspect, this present invention provides a method of fabricating an environmentally friendly cladding layer to solve the pollution problems caused from the traditional methods and reaches the same plating effect without the electrolytic solution.

In another aspect, this present invention provides a method of fabricating rolled metal layers to obtain large areas of metal layer to plate a large electroplate.

In yet another aspect, this present invention provides a quick plating method. A metal cladding structure is provided beforehand to save time and can then be covered on the surface of the electroplate. Furthermore, the present invention can be applied on a rough surface of the electroplate to plate a uniformly thick metal layer on the rough surface of the electroplate.

In accordance with the foregoing and other aspects of the present invention, the present invention provides a method of fabricating an environmentally friendly cladding layer. First, a metal layer is deposited on a hydrolysis film by a vacuum evaporation method. Then, the hydrolysis film is immersed in water after a polymer adhesive layer is formed on the metal layer. Alternatively, the polymer adhesive layer is formed on the metal layer after the hydrolysis film is immersed in water.

Next, an electroplate is adhered to the metal layer through the polymer adhesive layer. After the hydrolysis film is hydrolyzed to form a semi-dissolved hydrolysis film, the semi-dissolved hydrolysis film on the metal layer is washed and then dried to remove the water. Finally, the polymer adhesive layer, the metal layer and the electroplate are baked to thermoset the polymer adhesive layer. A polymer protective layer is optionally formed on the electroplate and the metal layer according to the demands. Then, the polymer protective layer is baked to thermoset the polymer protective layer.

According to another embodiment of the present invention, a method of fabricating an environmentally friendly cladding layer is provided. First, a metal layer is deposited on a hydrolysis film by a vacuum evaporation method. A polymer adhesive layer is formed on the metal layer. Then, a release paper is formed on the polymer adhesive layer to protect the polymer adhesive layer temporarily so that stickiness of the polymer adhesive layer can be preserved. Therefore, the time taken to plate the metal cladding structure on the electroplate can be greatly reduced.

The release paper is tom and then the electroplate is glued on the metal layer through the polymer adhesive layer. The polymer adhesive layer, the metal layer and the electroplate are baked to thermoset the polymer adhesive layer. Then, the hydrolysis film is immersed in water and hydrolyzed to form a semi-dissolved hydrolysis film. After that, the semi-dissolved hydrolysis film is washed and then the metal layer is dried. The cladding structure is baked. Finally, a polymer protective layer is optionally formed on the electroplate and the metal layer according to the demands and then baked to thermoset the polymer protective layer.

Thus, the present invention provides a method of fabricating an environmentally friendly cladding layer to solve those pollution problems caused from the traditional methods. A vacuum evaporation method is used to solve the problems of non-uniformly thick metal layer as yielded by the costly and time-consuming sputtering method. Moreover, larger areas of the metal layer can be obtained to plate a large electroplate by using a rolled metal cladding layer in a vacuum evaporation system.

Furthermore, the present invention can produce a metal cladding structure beforehand to be applied in plating the electroplate quickly to save operation time. The present invention can be applied on a rough surface electroplate to plate a uniformly thick metal layer on the rough surface of the electroplate. Moreover, the present invention can also be applied to a decorative ornament.

### BRIEF DESCRIPTION OF THE DRAWINGS

The invention can be more fully understood by reading the following detailed description of the preferred embodiment, with reference made to the accompanying drawings as follows:

FIG. 1 is a schematic diagram showing metal materials in a vacuum evaporation system according to one embodiment of the present invention.

FIG. 2 is a schematic diagram showing the hydrolysis film immersed in water according to one embodiment of the present invention.

FIG. 3 is a schematic diagram showing the polymer adhesive positioned on the electroplate according to one embodiment of the present invention.

FIG. 4 is a schematic diagram showing the metal layer adhered to the electroplate through the polymer adhesive.

FIG. 5 is a flowchart of fabricating an environmentally friendly cladding layer according to one embodiment of the present invention.

FIG. 6 is a flowchart of fabricating an environmentally friendly cladding material according to another embodiment of the present invention.

FIG. 7 is a schematic diagram showing a commercial metal cladding structure fabricated by performing step 402 to step 406 in FIG. 6.

### DESCRIPTION OF THE PREFERRED EMBODIMENTS

The present invention can solve the pollution problems caused by the traditional methods and also uses a vacuum evaporation method to solve the problems of a non-uniformly thick metal layer seen in the costly and time-consuming sputtering method. Reference will now be made in detail to the present preferred embodiments of the invention, examples of which are illustrated in the accompanying drawings. Wherever possible, the same reference numbers are used in the drawings and the description to refer to the same or like parts.

The present invention provides an electroplating method that uses water instead of an electrolytic solution but still as able to provide the same plating effect as the electrolytic solution.

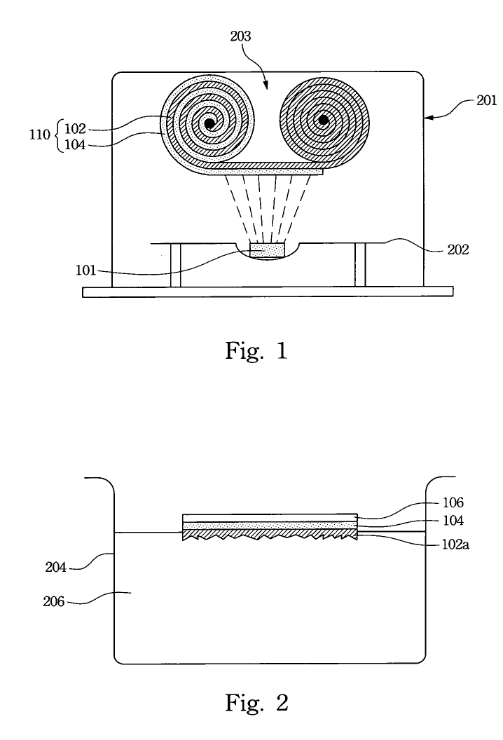

FIG. 1 is a schematic diagram showing metal materials in a vacuum evaporation system according to one embodiment of the present invention. In FIG. 1, a metal material 101 is positioned on a bowl 202 in a vacuum evaporation system 201. The metal material 101 is preferably Au, Ag, Co, Fe, Al, Zn, Sn, Co, Sb, Pb, Ni, or an alloy thereof.

Then, the metal material 101 is evaporated by a vacuum evaporation method to form a metal layer 104 on a hydrolysis film 102. The hydrolysis film 102 and the metal layer 104 form a metal cladding layer 110. The thickness of the metal layer 104 can be tens of nanometers to hundreds of nanometers. The hydrolysis film 102 is a water-soluble polymer that is preferably a polyvinyl alcohol. If the metal layer 104 having larger area are desired, the hydrolysis film 102 can be rolled up and placed on a rolling device 203, and then the metal layer 104 is deposited on the hydrolysis film 102 to obtain the metal cladding layer 110 having a large area.

A polymer adhesive is used for adhering the metal layer 104 to an electroplate according to one embodiment of the present invention. FIG. 2 is a schematic diagram showing the hydrolysis film immersed in water according to one embodiment of the present invention. The metal cladding layer 110 is removed from the vacuum evaporation system 201. Subsequently, a polymer adhesive is coated uniformly on the metal layer 104 to form a polymer adhesive layer 106 before the hydrolysis film 102 is immersed in a container 204 filled with water 206. Alternatively, the polymer adhesive is coated uniformly on the metal layer 104 after the hydrolysis film 106 is immersed in the container 204 filled with water 206.

The materials of the polymer adhesive are preferably epoxy resin, polyurethane resin, acrylic resin, phenolic resin and urea resin. However, the hydrolysis film 102 is a water-soluble polymer so that the hydrolysis film 102 is partially hydrolyzed in water 206 to form a semi-dissolved hydrolysis film 102a after the hydrolysis film 102 is immersed in water 206.

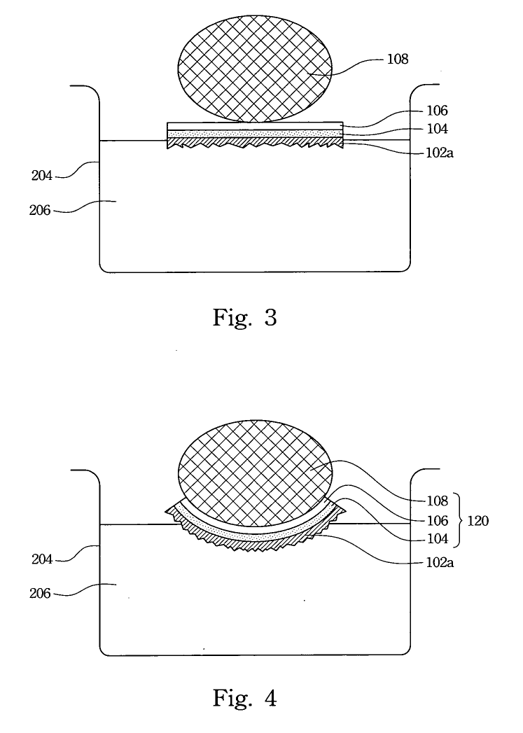

FIG. 3 is a schematic diagram showing an electroplate on the polymer adhesive according to one embodiment of the present invention. In FIG. 3, an electroplate 108 is positioned on the polymer adhesive layer 106. At this time, only the center area of the polymer adhesive layer 106 is glued on the the electroplate 108 and the other area of the polymer adhesive layer 106 is not adhered to the electroplate 108. The electroplate 108 is made of, for example, a metal, ceramic, plastic, or other material.

FIG. 4 is a schematic diagram showing the metal layer adhered to the electroplate through the polymer adhesive. In FIG. 4, the electroplate 108 falls by gravity to let the other areas of the polymer adhesive layer 106 and the metal layer 104 cover the surface of the electroplate 108 so that the metal layer 104 can be adhered to the surface of the electroplate 108 uniformly.

After that, the semi-dissolved hydrolysis film 102a on the metal layer 104 is washed by clean water and then the metal layer 104 is dried to remove water. Therefore, a cladding structure 120 is formed, which is composed of the metal layer 104, the polymer adhesive layer 106 and the electroplate 108.

Finally, the cladding structure 120 is removed from the container 204 and then baked at preferred temperature to thermoset the polymer adhesive layer 106 to adhere the metal layer 104 to the electroplate 108 firmly. The preferred temperature can be determined by different electroplates according to the demands. For example, if the electroplate is a metal, the preferred temperature is about 100° C. and the baking time is preferably about half an hour. If the electroplate is a non-metal, the temperature is preferably about 60° C. and the baking time is preferably about half an hour.

Subsequently, a polymer protective layer is formed on the surface of the metal layer 104 and the electroplate 108 of the cladding structure 120 to protect the electroplate 108 and the metal layer 104 of the cladding structure 120 according to the demands. The material of the polymer protective layer is preferably polyurethane. Then, the protective layer is baked at preferred temperature to thermoset the polymer protective layer. The preferred temperature is the same as the preferred temperature of the cladding structure 120 mentioned above.

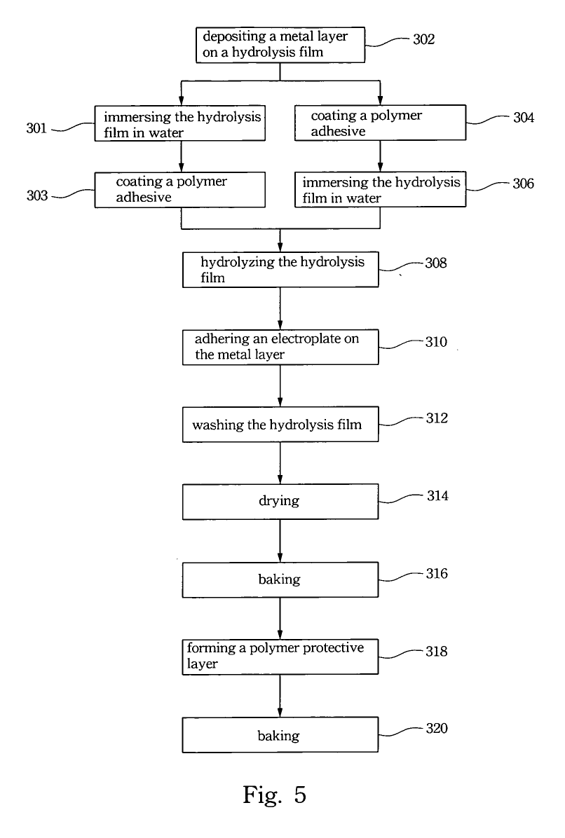

FIG. 5 is a flowchart of fabricating an environmentally friendly cladding layer according to one embodiment of the present invention. Reference is made to FIGS. 1 to 4. In step 302, a metal layer is deposited on a hydrolysis film. Then, a polymer adhesive is coated on the metal layer in step 304 before the hydrolysis film is immersed in water in step 306. Alternatively, the polymer adhesive is coated on the metal layer in step 303 after the hydrolysis film is immersed in water in step 301.

Next, the hydrolysis film is hydrolyzed to form a semi-dissolved hydrolysis film in step 308. An electroplate is adhered to the metal layer through the polymer adhesive in step 310. The semi-dissolved hydrolysis film on the metal layer is washed in step 312 and then the metal layer is dried in step 314. The polymer adhesive, the metal layer and the electroplate are baked in step 316. Finally, a polymer protective layer is formed according to the demands in step 318 and then the polymer protective layer is baked in step 320.

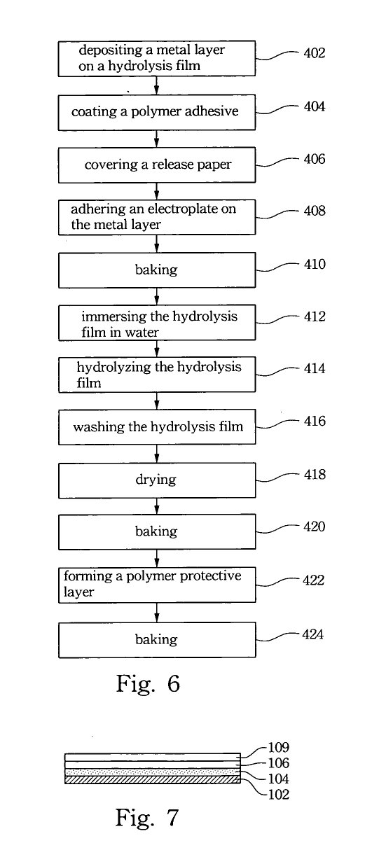

However, the steps mentioned above can be adjusted to obtain a commercialized metal layer according the demands. FIG. 6 is a flowchart of fabricating an environmentally friendly cladding layer according to another embodiment of the present invention. First, a metal layer is deposited on a hydrolysis layer by a vacuum evaporation method in step 402. A polymer adhesive is coated on the metal layer in step 404. However, the difference from the embodiment mentioned above is that a release paper is covered on the polymer adhesive to protect the polymer adhesive temporarily in step 406 so that stickiness of the polymer adhesive can be preserved. Therefore, a commercial metal cladding structure is obtained and thus plating time of the metal cladding structure covered on the electroplate can be reduced.

The release paper is peeled away and then the electroplate is glued on the metal layer through the polymer adhesive layer in step 408. The polymer adhesive layer, the metal layer and the electroplate are baked in step 410. Then, the hydrolysis film is immersed in water in step 412 and hydrolyzed in step 414 to form a semi-dissolved hydrolysis film. After that, the semi-dissolved hydrolysis film is washed in step 416 and then the metal layer is dried in step 418. The cladding structure is baked in step 420. Finally, a polymer protective layer is formed in step 422 and then baked in step 424.

The release paper is preferably silicone resin. FIG. 7 is a schematic diagram showing a commercial metal cladding structure obtained by performing step 402 to step 406 in FIG. 6. In FIG. 7, the release paper 109 mentioned above is covered on the polymer adhesive layer 106 to protect the polymer adhesive layer 106. The materials of the polymer adhesive layer, the metal layer and the hydrolysis film are the same as those of the embodiment mentioned above.

Thus, the present invention provides a method of fabricating an environmentally friendly cladding layer to solve the pollution problems caused from the traditional methods. A vacuum evaporation method is used to solve the problems of non-uniformly thick metal layer yielded by the costly and time-consuming sputtering method. Moreover, larger areas of the metal layer can be obtained to plate a large electroplate by using a rolled metal cladding layer in a vacuum evaporation system.

Furthermore, the present invention can produce a metal cladding structure beforehand to be applied in plating the electroplate quickly to save operation time. The present invention can plate a uniformly thick metal layer on a rough surface of an electroplate. Moreover, the present invention can also be applied in a decorative ornament.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of fabricating an environmentally friendly cladding layer, the method comprising:
depositing a metal layer on a hydrolysis film by a vacuum evaporation method;
immersing the hydrolysis film in water;
coating a polymer adhesive on the metal layer;
adhering an electroplate on the metal layer through the polymer adhesive;
hydrolyzing the hydrolysis film to remove the hydrolysis film; and
baking the polymer adhesive, the electroplate and the metal layer to solidify the polymer adhesive.

2. The method of fabricating an environmentally friendly cladding layer of claim 1, wherein a material of the metal layer is selected from a group consisting of Au, Ag, Co, Fe, Al, Zn, Sn, Co, Sb, Pb, Ni, and an alloy thereof.

3. The method of fabricating an environmentally friendly cladding layer of claim 1, wherein the hydrolysis film comprises a water-soluble polymer.

4. The method of fabricating an environmentally friendly cladding layer of claim 3, wherein the water-soluble polymer comprises a polyvinyl alcohol.

5. The method of fabricating an environmentally friendly cladding layer of claim 1, wherein a thickness of the metal layer is from tens of nanometers to hundreds of nanometers.

6. The method of fabricating an environmentally friendly cladding layer of claim 1, wherein a material of the polymer adhesive is selected from a group consisting of epoxy resin, polyurethane resin, acrylic resin, phenolic resin and urea resin.

7. The method of fabricating an environmentally friendly cladding layer of claim 1, wherein a material of the electroplate is selected from a group consisting of metal, ceramic, and plastic.

8. The method of fabricating an environmentally friendly cladding layer of claim 1, wherein the baking temperature is about 60° C. to about 100° C. for about 30 minutes.

9. The method of fabricating an environmentally friendly cladding layer of claim 1, further comprising forming a polymer protective layer on a surface of the electroplate to form a protective layer, wherein the polymer protective layer comprises a polyurethane.

10. The method of fabricating an environmentally friendly cladding layer of claim 1, further comprising baking the polymer protective layer to thermoset the polymer protective layer.

11. An environmentally friendly cladding layer structure, the environmentally friendly cladding layer structure comprising:
an electroplate;
a thermosetting polymer adhesive; and
a metal layer glued on the electroplate through the thermosetting polymer adhesive

12. The environmentally friendly cladding layer structure of claim 11, wherein a material of the electroplate is selected from a group consisting of metal, ceramic, and plastic.

13. The environmentally friendly cladding layer structure of claim 11, wherein a material of the thermosetting polymer adhesive is selected from a group consisting of epoxy resin, polyurethane resin, acrylic resin, phenolic resin and urea resin.

14. The environmentally friendly cladding layer structure of claim 11, wherein a material of the metal layer is selected from a group of Au, Ag, Co, Fe, Al, Zn, Sn, Co, Sb, Pb, Ni, and an alloy thereof.

15. The environmentally friendly cladding layer structure of claim 11, wherein a thickness of the metal layer is from tens of nanometers to hundreds of nanometers.

16. The environmentally friendly cladding layer structure of claim 11, further comprising a polymer protective layer on the metal layer, wherein the polymer protective layer comprises a polyurethane.

17. An environmentally friendly cladding layer, the environmentally friendly cladding layer comprising:
a hydrolysis film;
a metal layer on the hydrolysis film; and
a polymer adhesive layer on the metal layer.

18. The environmentally friendly cladding layer of claim 17, wherein the hydrolysis film comprises a water-soluble polymer.

19. The environmentally friendly cladding layer of claim 17, wherein the water-soluble polymer comprises a polyvinyl alcohol.

20. The environmentally friendly cladding layer of claim 17, wherein materials of a metal layer is selected from a group consisting of Au, Ag, Co, Fe, Al, Zn, Sn, Co, Sb, Pb, Ni, and an alloy thereof.

21. The environmentally friendly cladding layer of claim 17, wherein a thickness of the metal layer is from tens of nanometers to hundreds of nanometers.

22. The environmentally friendly cladding layer of claim 17, wherein a material of the polymer adhesive layer is selected from a group consisting of epoxy resin, polyurethane resin, acrylic resin, phenolic resin and urea resin.

23. The environmentally friendly cladding layer of claim 17, further comprising a release paper on the polymer adhesive layer, wherein a material of the release paper comprises silicone resin.
